(19) United States
(12) Patent Application Publication
(10) Pub. No.: US 2015/0229921 A1
(43) Pub. Date: Aug. 13, 2015

(54) INTRA SEARCHES USING INACCURATE NEIGHBORING PIXEL DATA

(71) Applicant: NVIDIA CORPORATION, Santa Clara, CA (US)

(72) Inventors: Jianjun CHEN, Shanghai (CN); Yemin MA, Shanghai (CN)

(73) Assignee: NVIDIA CORPORATION, Santa Clara, CA (US)

(21) Appl. No.: 14/178,193

(22) Filed: Feb. 11, 2014

(51) Int. Cl. H04N 19/105

(52) U.S. Cl. CPC H04N 19/105; H04N 19/533; H04N 19/136; H04N 19/176

(57) ABSTRACT

One embodiment of the present invention sets forth a technique for performing an intra search. The technique includes performing a first intra search based on a first block size associated with a first pixel block included in a video frame to determine a first intra mode. The technique further includes reconstructing the first pixel block based on the first intra mode to generate reconstructed pixel data. The technique further includes performing, based on the reconstructed pixel data, a second intra search based on a second block size associated with a second pixel block included in the video frame. The second block size is smaller than the first block size. The technique further includes determining a second intra mode based on the second intra search. Advantageously, the disclosed technique enables an intra search to be performed based on a previous intra search size, enabling intra searches to be performed in parallel.

### BACKGROUND OF THE INVENTION

1. Field of the Invention

Embodiments of the present invention generally relate to video processing and, more specifically, to intra search techniques using inaccurate neighboring pixel data.

2. Description of the Related Art

Video compression techniques generally enable the data rate of a video stream to be reduced without significantly affecting picture quality. As a result, high-quality video can be stored using a smaller amount of memory and/or can be transmitted over a network using less bandwidth. Additionally, video compression enables high-quality graphical user interface (GUI) images to be transmitted over a network to a user more quickly, allowing the user to interact with the GUI substantially in real-time.

In general, lossy video compression algorithms compress video frame data by detecting similarities between macroblocks or coding tree units in a given video frame and/or between a given video frame and one or more preceding and/or subsequent video frames. For example, inter-frame compression algorithms detect similarities and differences between macroblocks in a current video frame and macroblocks in a preceding video frame and/or subsequent video frame. Inter-frame compression algorithms then encode the current video frame by storing the differences between the preceding video frame and the current video frame and/or the differences between the subsequent video frame and the current video frame. Intra-frame compression algorithms, on the other hand, detect similarities and differences between different macroblocks included in the same video frame. The differences between a particular macroblock in the video frame and one or more neighboring macroblocks included in the video frame are then stored in the intra-frame.

Although intra-frame compression algorithms allow the data rate of a video stream to be significantly reduced, the dependencies between neighboring macroblocks in an intra-frame can create a bottleneck in the video encoding pipeline. For example, because the macroblocks in each intra-frame are encoded by searching for similar content in neighboring macroblocks, neighboring macroblocks must be reconstructed prior to performing an intra search for a particular macroblock. Consequently, conventional video encoding techniques do not permit intra searches for neighboring macroblocks to be performed in parallel, which reduces the performance of conventional video encoding techniques.

As the foregoing illustrates, there is a need in the art for a more effective way to apply intra-frame compression algorithms to a stream of video data.

### SUMMARY OF THE INVENTION

One embodiment of the present invention sets forth a method for performing an intra search. The method includes performing a first intra search based on a first block size associated with a first pixel block included in a video frame to determine a first intra mode. The method further includes reconstructing the first pixel block based on the first intra mode to generate reconstructed pixel data. The method further includes performing, based on the reconstructed pixel data, a second intra search based on a second block size associated with a second pixel block included in the video frame. The second block size is smaller than the first block size. The method further includes determining a second intra mode based on the second intra search.

Further embodiments provide, among other things, a non-transitory computer-readable medium and a computing device configured to carry out method steps set forth above.

Advantageously, the disclosed technique enables an intra search to be performed based on a previous intra search size. As a result, dependencies between neighboring pixel blocks are reduced, enabling intra searches to be performed for neighboring pixel blocks in parallel. Accordingly, intra-frame encoding bottlenecks are reduced, and video encoding performance is increased.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a system configured to implement one or more aspects of the present invention;

FIG. 2 is a block diagram of a parallel processing unit (PPU) included in the parallel processing subsystem of FIG. 1, according to one embodiment of the present invention;

FIG. 3 is a block diagram of the encoder included in the PPU of FIG. 2, according to one embodiment of the present invention;

FIGS. 4A and 4B illustrate a conventional technique for performing intra searches based on different block sizes;

FIGS. 5A-5D illustrate a technique for performing an intra search based on inaccurate neighboring pixel data, according to one embodiment of the present invention; and

FIG. 6 is a flow diagram of method steps for performing an intra search, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

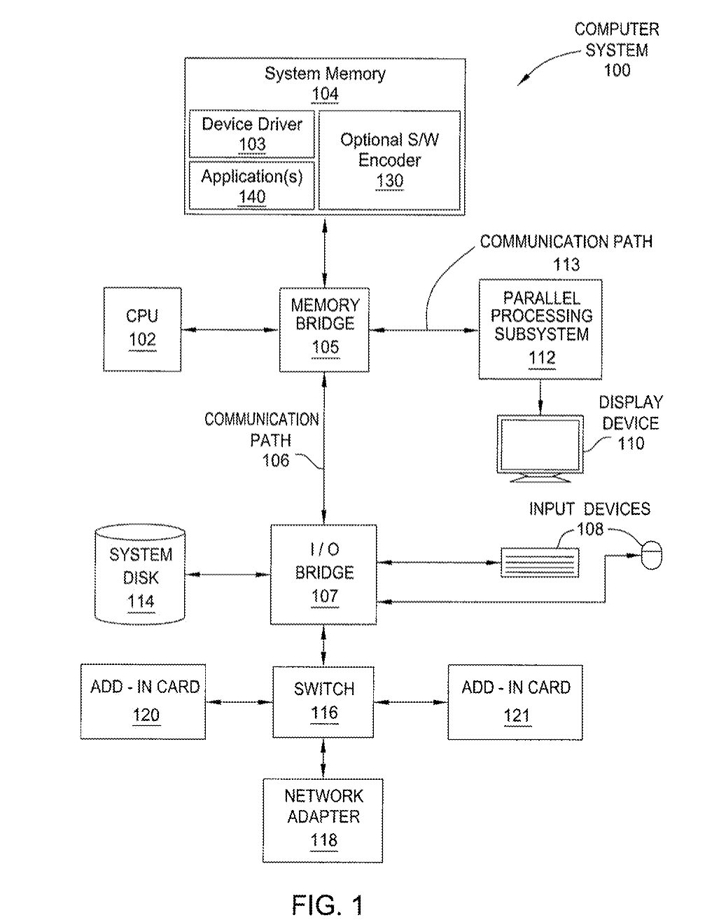

FIG. 1 illustrates a system configured to implement one or more aspects of the present invention. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbrige chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

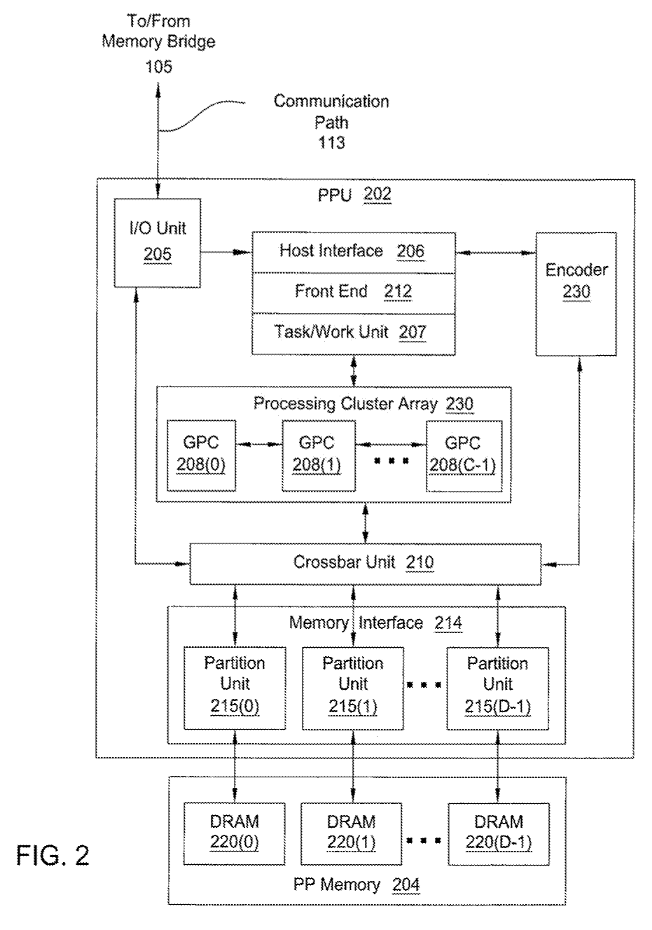

In some embodiments, parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in FIG. 2, such circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations.

System memory 104 includes at least one device driver 103 configured to manage the processing operations of the one or more PPUs within parallel processing subsystem 112. System memory 104 may further include an optional software encoder 130 and one or more applications 140. The optional software encoder 130 is configured to receive and encode images, such as graphical user interface (GUI) images, video streams, and the like, to generate encoded video frames.

In various embodiments, parallel processing subsystem 112 may be integrated with one or more other elements of FIG. 1 to form a single system. For example, parallel processing subsystem 112 may be integrated with CPU 102 and other connection circuitry on a single chip to form a system-on-chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) included in the parallel processing subsystem of FIG. 1, according to one embodiment of the present invention. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computer system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computer system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end unit 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D≧1. Each partition unit 215 is coupled to one or more dynamic random access memories (DRAMs) 220 residing within PPM memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPCs 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

As noted above, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

PPU 202 may include an encoder 230 that receives processing tasks from the host interface 206 and communicates with memory interface 214 via crossbar unit 210 to read from and/or write to the DRAMs 220. For example, the encoder 230 may be configured to read frame data (e.g., YUV or RGB pixel data) from the DRAMs 220 and apply a video compression algorithm to the frame data to generate encoded video frames. Encoded video frames may then be stored in the PP memory 204 and/or transmitted through the crossbar unit 210 to the I/O Unit 205.

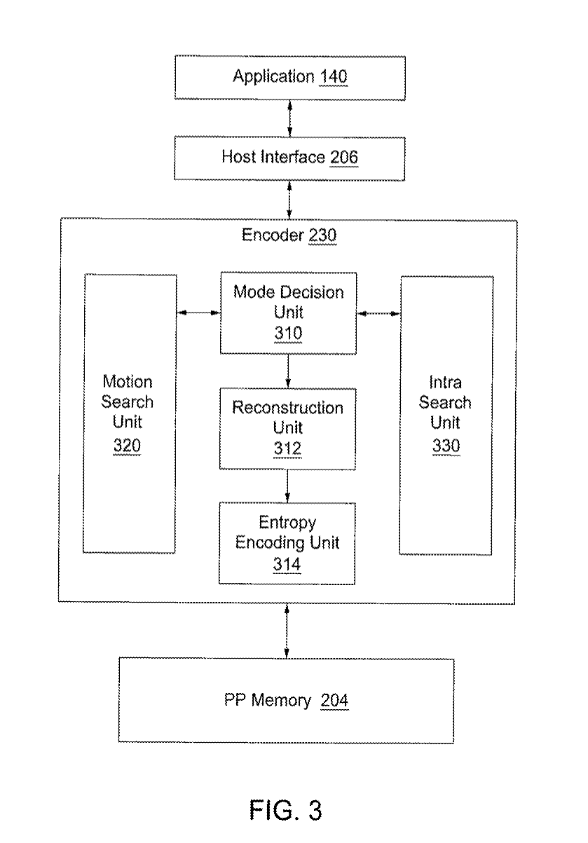

FIG. 3 is a block diagram of the encoder included in the PPU of FIG. 2, according to one embodiment of the present invention. The encoder 230 includes a mode decision unit 310 that selects a video compression algorithm to be applied video frame data. The mode decision unit 310 may select a video compression algorithm based on various types of video frame statistics, such as motion vectors, received from the motion search unit 320 and/or the intra search unit 330. The encoder 230 further includes a reconstruction unit 312 and an entropy encoding unit 314. The reconstruction unit 312 may be configured to process and combine inter-frame and intra-frame compression data to reconstruct pixels included in encoded frame data. The entropy encoding unit 314 may be configured to further compress the frame data by assigning one or more codes to unique symbols included in the frame data. The intra search unit 330 may be configured to perform an intra search based on various block sizes (e.g., 16×16 pixels, 16×8 pixels, 8×8 pixels, 8×4 pixels, 4×4 pixels, etc.) and select an intra-frame prediction mode (e.g., vertical, horizontal, diagonal, etc.) to compress a video frame.

The encoder 230 may be configured to encode frame data based on different video compression algorithms, such as H.263, H.264, VP8, High Efficiency Video Coding (HEVC), and the like. In general, lossy video compression algorithms compress frame data using a combination of inter-frame compression algorithms and intra-frame compression algorithms. Inter-frame compression algorithms reduce video data rate by detecting similarities between macroblocks (e.g., 16×16 pixel blocks) or coding tree units in a given video frame and macroblocks or coding tree units in one or more preceding video frames and/or subsequent video frames. For example, the motion search unit 320 may detect similarities and differences between macroblocks in a current video frame and macroblocks in a preceding video frame. The encoder 230 may then apply an inter-frame compression algorithm to the current video frame by storing what has changed between the preceding video frame and the current video frame and consolidating frame data that is similar between the preceding video frame and the current video frame. That is, the current video frame is encoded with reference to the preceding video frame. This technique is commonly referred to as predictive frame (P-frame) encoding.

Additionally, when applying another type of inter-frame compression algorithm, the motion search unit 320 may detect similarities and differences between macroblocks in a current video frame and macroblocks in both a preceding video frame and a subsequent video frame. The encoder 230 may then apply the inter-frame compression algorithm to the current video frame by storing the differences between the preceding video frame and the current video frame as well as the differences between the subsequent video frame and the current video frame. Additionally, frame data that similar between the preceding video frame and the current video frame as well as between the subsequent video frame and the current video frame may be consolidated. This technique is commonly referred to as bi-directional frame (B-frame) encoding.

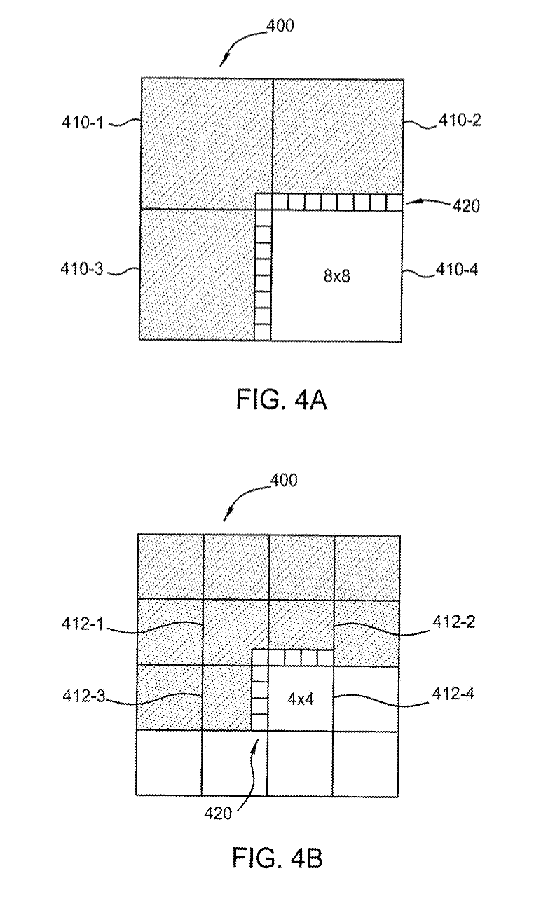

In contrast to the inter-frame compression algorithms described above, intra-frame compression algorithms reduce video data rate by compressing individual video frames in isolation, without reference to preceding video frames or subsequent video frames. For example, the intra search unit 330 may detect similarities between macroblocks or coding tree units included in a single video frame. The encoder 230 may then apply an intra-frame compression algorithm to perform spatial compression by consolidating these similarities, reducing the size of the video frame without significantly affecting the visual quality of the video frame. An exemplary video frame encoded based on an intra-frame compression algorithm is described in further detail below in conjunction with FIGS. 4A and 4B.

FIGS. 4A and 4B illustrate a conventional technique for performing intra searches based on different block sizes. In general, intra-frame compression is performed on a video frame by intra searching pixel blocks and reconstructing the pixel blocks based on a selected intra mode. Intra searching and reconstruction is performed in a direction that begins at the upper-left corner of the video frame and ends at the bottom-right corner of the video frame. That is, intra searching is performed for a particular pixel block by referencing reconstructed neighboring pixels that are located above and/or to the left of the pixel block to determine an optimal intra mode (e.g., vertical, horizontal, diagonal, etc.). The pixel block is then reconstructed based on the intra mode, and the process is repeated for the next pixel block. For example, as shown in FIG. 4A, an intra search of pixel block 410-4 may be performed based on neighboring pixels 420 included in pixel blocks 410-1, 410-2, 410-3 that have already been intra searched and reconstructed by an encoder. Similarly, as shown in FIG. 4B, an intra search of pixel block 412-4 may be performed based on neighboring pixels 420 included in pixel blocks 412-1, 412-2, 412-3 that have already been intra searched and reconstructed by an encoder.

The process of intra searching and reconstructing pixel blocks is typically performed using specific pixel block sizes, such as 16×16 pixel blocks, 8×8 pixel blocks, 4×4 pixel blocks, and the like. For example, a conventional technique for encoding an intra-frame may begin by first dividing a video frame 400 into 16×16 pixel blocks and performing an intra search and reconstruction for the 16×16 pixel blocks in a top-left to bottom-right encoding direction. The encoder may then divide the video frame 400 into 8×8 pixel blocks and perform an intra search and reconstruction for the 8×8 pixel blocks. Additionally, after intra searching and reconstruction of the 8×8 pixel blocks, the encoder may divide the video frame 400 into 4×4 pixel blocks and perform an intra search and reconstruction for each 4×4 pixel block. The encoder may then compare the results of the intra searches to determine which block size (e.g., 16×16, 8×8, 4×4, etc.) produces optimal results for each region of the video frame 400. Determining the optimal block size for a particular region of the video frame 400 may be based on criteria such as compression efficiency, encoded data size, prediction error, image distortion, and/or Lagrangian evaluation techniques. The video frame 400 may then be encoded using the optimal block size(s) and intra mode(s) determined for each region of the video frame 400.

One consequence of encoding intra-frames in the manner described above is that an intra search for a particular pixel block can be performed only once the neighboring blocks upon which the pixel block depends have been intra searched and reconstructed. For example, in FIG. 4B, an intra search cannot be performed for pixel block 412-4 until the pixel blocks located above and to the left of pixel block 412-4 (e.g., pixel blocks 412-1, 412-2, and 412-3) have been intra searched and reconstructed. Consequently, multiple pixel blocks cannot be intra searched in parallel, creating a bottleneck in the video encoding pipeline and, thus, increasing encoding latency.

### Intra Searching Using Inaccurate Neighboring Pixel Data

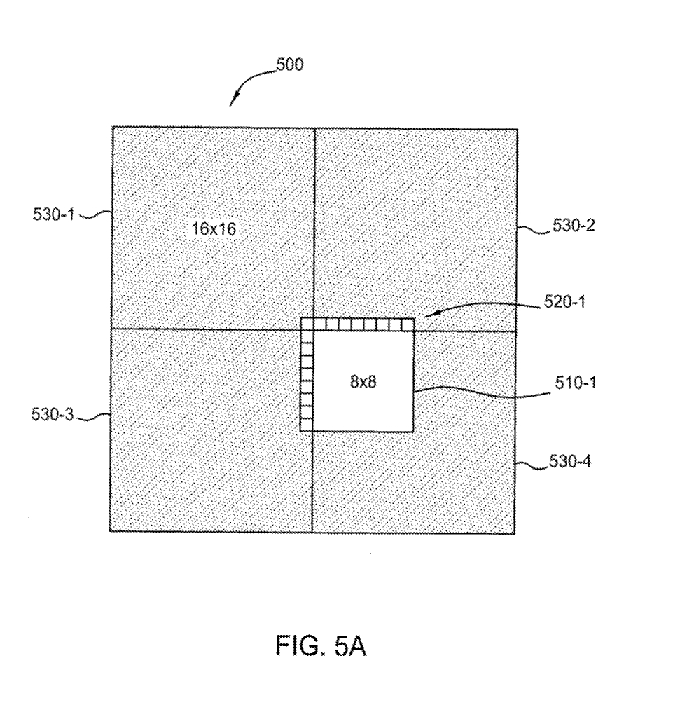

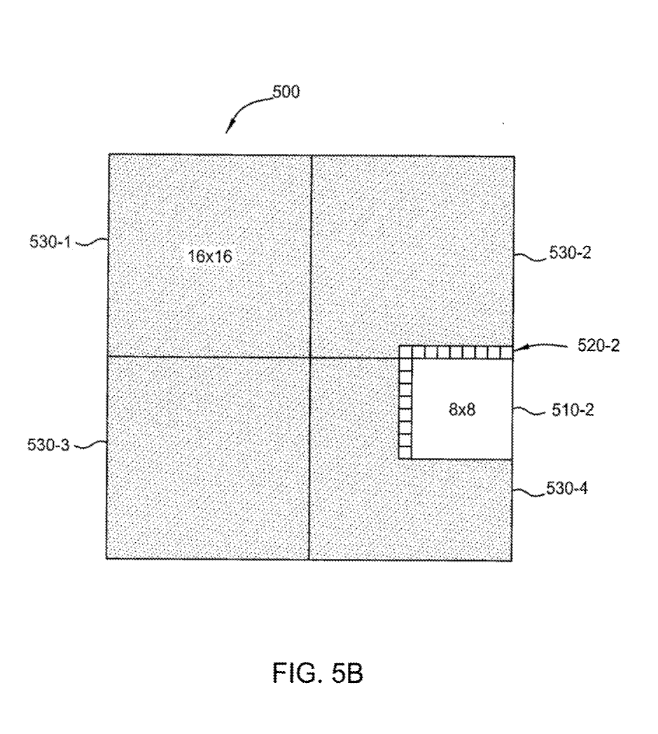

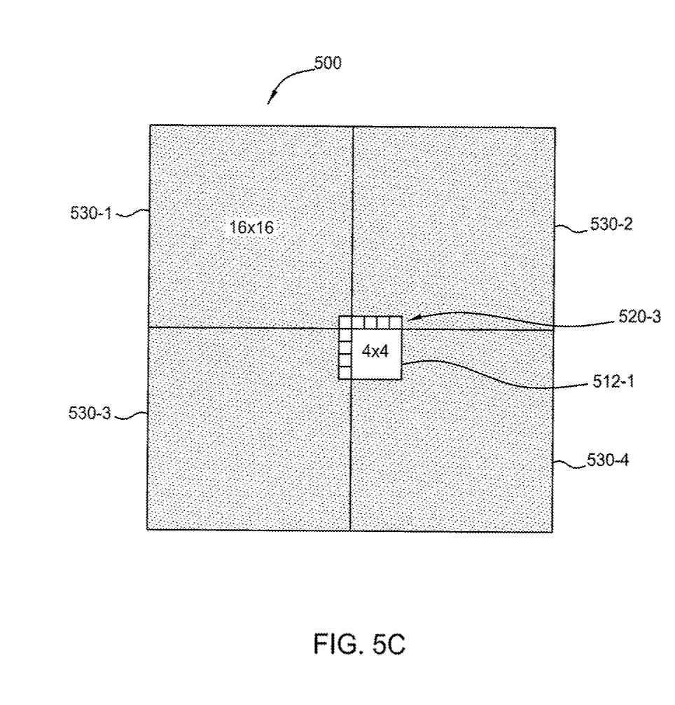

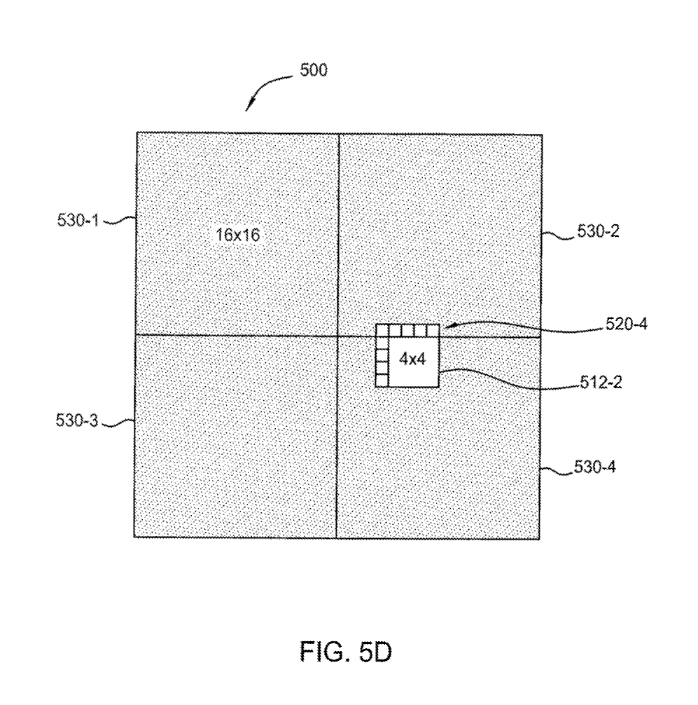

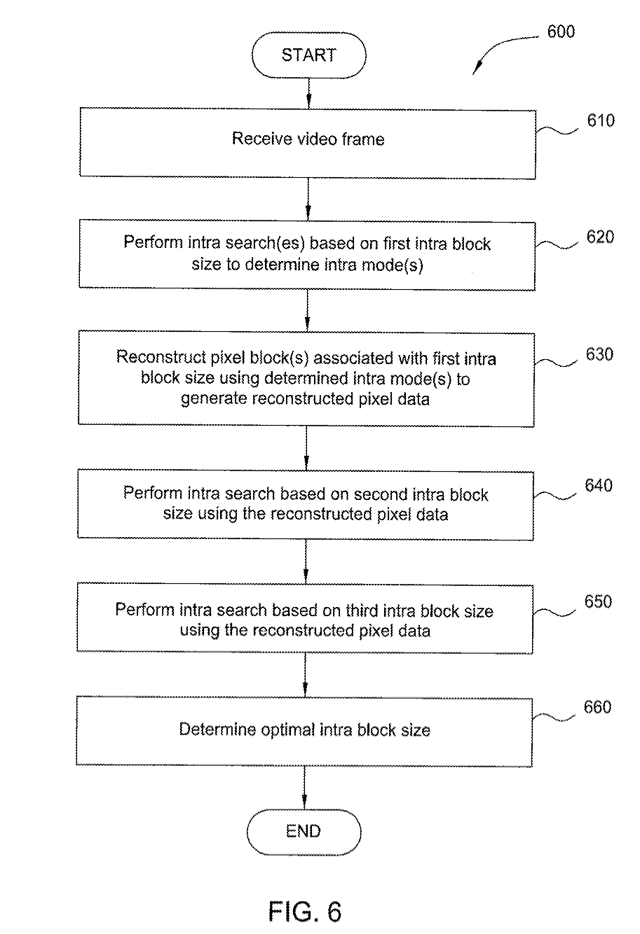

To address the shortcomings described above, in various embodiments, an intra search for a particular pixel block may be performed using reconstructed pixel data that was generated during a previous intra search, such as a previous intra search based on a different block size. For example, after performing a 16×16 intra search and reconstructing pixel blocks having a block size of 16×16 pixels, the intra search unit 330 may perform an 8×8 intra search using the reconstructed pixel data that was generated during the 16×16 intra search. Thus, by using reconstructed pixel data that was generated during a previous intra search, dependencies between neighboring 8×8 pixel blocks are reduced or eliminated, and the 8×8 intra searches can be performed by the intra search unit 330 in parallel. Accordingly, using less accurate reconstructed pixel data generated during a previous intra search and reconstruction pass may significantly improve intra-frame encoding performance. Such techniques are described below in further detail in conjunction with FIGS. 5A-6.

FIGS. 5A-5D illustrate techniques for performing an intra search based on inaccurate neighboring pixel data, according to one embodiment of the present invention. As shown in FIG. 5A, 8×8 pixel block 510-1 may be intra searched using reconstructed pixels 520-1 included in one or more 16×16 pixel blocks 530 (e.g., pixel blocks 530-1, 530-2, and 530-3). Additionally, as shown in FIG. 5B, 8×8 pixel block 510-2 may be intra searched using reconstructed pixels 520-2 included in 16×16 pixel blocks 530-2 and 530-4. Moreover, because the intra search of pixel block 510-2 is not dependent on the intra search and reconstruction of pixel block 510-1, the intra searches associated with pixel blocks 510-1 and 510-2 may be performed in parallel.

In general, intra searches performed using reconstructed pixel data associated with a different block size are less accurate than intra searches performed using reconstructed pixel data associated with the same block size. As a result, the accuracy of the intra searches may be reduced, for example, by causing a less-than-optimal intra mode to be selected by the intra search unit 330. However, evaluation of intra-frames encoded using the inaccurate neighboring pixel data techniques described herein indicates that, in most cases, intra-frame image quality is similar to the image quality that is achieved when intra searches are performed using reconstructed pixel data associated with the same block size. As a result, enabling intra searches to be performed in parallel, using inaccurate neighboring pixel data, significantly improves video encoding performance without noticeably degrading image quality of the resulting intra-frames.

In addition to intra searching 8×8 pixel blocks 510 using neighboring pixels 520 included in one or more reconstructed 16×16 pixel blocks 530, any other square and/or rectangular block size may be intra searched using reconstructed pixel data that was previously generated based on a different square and/or rectangular block size. For example, as shown in FIGS. 5C and 50, intra searches may be performed with 4×4 pixel blocks 512-1 and 512-2 using reconstructed pixels 520-3 and 520-4, respectively, included in 16×16 pixel blocks 530-1, 530-2, 530-3, and/or 530-4. Further, in the same or other embodiments, an intra search may be performed with a 4×4 pixel block (e.g., pixel block 512-2) using reconstructed pixels included in one or more 8×8 pixel blocks (e.g., pixel block 510-1) or any other block size (e.g., 4×8, 8×4, 8×16, 16×8, etc.) for which an intra search and reconstruction pass has been performed.

FIG. 6 is a flow diagram of method steps for performing an intra search, according to one embodiment of the present invention. Although the method steps are described in conjunction with the systems of FIGS. 1-3 and 5A-5D, persons skilled in the art will understand that any system configured to perform the method steps, in any order, falls within the scope of the present invention.

As shown, a method 600 begins at step 610, where the encoder 230 (and/or optional software encoder 130) receives a video frame 500 to be encoded. At step 620, the intra search unit 330 performs one or more intra searches based on a first block size (e.g., a 16×16 pixel block size) to determine an intra mode for one or more pixel blocks. At step 630, the reconstruction unit 312 reconstructs the one or more pixel blocks associated with the intra search(es) based on the selected intra mode(s).

Next, at step 640, the intra search unit 330 uses the reconstructed pixel data associated with the one or more pixel blocks (e.g., 16×16 pixel blocks) to perform an intra search based on a second block size (e.g., an 8×8 pixel block size). When performing the intra search, the intra search unit 330 may determine an optimal intra mode for each pixel block having the second block size. In various embodiments, the second block size is smaller than the first block size. At step 650, the intra search unit 330 uses the reconstructed pixel data associated with the one or more pixel blocks (e.g., 16×16 pixel blocks) to perform one or more intra searches based on a third block size (e.g., a 4×4 pixel block size). When performing the intra search(es), the intra search unit 330 may determine an optimal intra mode for each pixel block having the third block size. In various embodiments, the third block size is smaller than both the first block size and the second block size.

At step 660, the intra search unit 330 and/or the mode decision unit 310 determines the optimal block size. In some embodiments, the optimal block size may be determined by comparing results associated with the second block size to results associated with the third block size based on criteria such as compression efficiency, encoded data size, prediction error, image distortion, Lagrangian evaluation techniques, and the like. If the second block size is more favorable than the third block size, then one or more pixel blocks may be encoded using the second block size. If the second block size is not more favorable than the third block size, then one or more pixel blocks may be encoded using the third block size. After determining the optimal block size at step 660, the method 600 ends.

In sum, an encoder receives a video frame and performs an intra search based on a first block size, such as a block size of 16×16 pixels, via an intra search unit. A reconstruction unit then reconstructs pixels associated with the first block size. Next, the intra search unit performs an intra search based on a second block size, such as a block size of 8×8 pixels, using the reconstructed pixel data associated with the first block size. The intra search unit may further perform an intra search based on a third block size, such as a block size of 4×4 pixels, using the reconstructed pixel data associated with the first block size. An optimal block size may then be selected by the intra search unit.

One advantage of the technique described herein is that an intra search can be performed based on a previous intra search size. As a result, dependencies between neighboring pixel blocks are reduced, enabling intra searches to be performed for neighboring pixel blocks in parallel. Accordingly, intra-frame encoding bottlenecks are reduced, and video encoding performance is increased.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

What is claimed is:

1. A computer-implemented method for performing an intra search, the method comprising:
performing a first intra search based on a first block size associated with a first pixel block included in a video frame to determine a first intra mode;
reconstructing the first pixel block based on the first intra mode to generate reconstructed pixel data;
performing, based on the reconstructed pixel data, a second intra search based on a second block size associated with a second pixel block included in the video frame, wherein the second block size is smaller than the first block size; and
determining a second intra mode based on the second intra search.

2. The method of claim 1, wherein the first block size is 16×16 pixels, and the second block size is 8×8 pixels.

3. The method of claim 1, wherein the first pixel block and the second pixel block are neighboring pixel blocks within the video frame.

4. The method of claim 1, further comprising reconstructing a third pixel block included in the first pixel block and having the second block size, wherein the second intra search is performed prior to reconstructing the third pixel block.

5. The method of claim 1, wherein the second pixel block is included in the first pixel block.

6. The method of claim 1, further comprising performing a third intra search based on the second block size associated with a third pixel block included in the first pixel block to determine a third intra mode, wherein the second intra search and the third intra search are performed substantially in parallel.

7. The method of claim 6, further comprising performing a fourth intra search based on the second block size associated with a fourth pixel block included in the video frame, and performing a fifth intra search based on the second block size associated with a fifth pixel block included in the video frame, wherein the second infra search, the third intra search, the fourth intra search, and the fifth intra search are performed substantially in parallel.

8. The method of claim 1, further comprising:
performing a third infra search based on a third block size associated with a third pixel block included in the second pixel block, wherein the third block size is smaller than the second block size;
determining a third intra mode based on the third intra search;
comparing first results associated with the second block size to second results associated with the third block size to determine that the second block size is optimal; and
in response, encoding the second pix block based on the second intra mode.

9. The method of claim 8, wherein the first block size is 16×16 pixels, the second block size is 8×8 pixels, and the third block size is 4×4 pixels.

10. A computing device, comprising:
a memory; and
a video encoder coupled to the memory and configured to perform an intra search by:
performing a first intra search based on a first block size associated with a first pixel block included in a video frame to determine a first intra mode;
reconstructing the first pixel block based on the first intra mode to generate reconstructed pixel data;
performing, based on the reconstructed pixel data, a second intra search based on a second block size associated with a second pixel block included in the video frame, wherein the second block size is smaller than the first block size; and
determining a second intra mode based on the second intra search.

11. The computing device of claim 10, wherein the first block size is 16×16 pixels, and the second block size is 8×8 pixels.

12. The computing device of claim 10, wherein the first pixel block and the second pixel block are neighboring pixel blocks within the video frame.

13. The computing device of claim 10, wherein the video encoder is further configured for reconstructing a third pixel block included in the first pixel block and having the second block size, and the second intra search is performed prior to reconstructing the third pixel block.

14. The computing device of claim 10, wherein the second pixel block is included in the first pixel block.

15. The computing device of claim 10, wherein the video encoder is further configured for performing a third intra search based on the second block size associated with a third pixel block included in the first pixel block to determine a third intra mode, and the second intra search and the third intra search are performed substantially in parallel.

16. The computing device of claim 15, wherein the video encoder is further configured for performing a fourth intra search based on the second block size associated with a fourth pixel block included in the video frame, and performing a fifth intra search based on the second block size associated with a fifth pixel block included in the video frame, and the second intra search, the third intra search, the fourth intra search, and the fifth intra search are performed substantially in parallel.

17. The computing device of claim 10, wherein the video encoder is further configured for:
performing a third intra search based on a third block size associated with a third pixel block included in the second pixel block, wherein the third block size is smaller than the second block size;
determining a third intra mode based on the third intra search;
comparing first results associated with the second block size to second results associated with the third block size to determine that the second block size is optimal; and
in response encoding the second pixel block based on the second intra mode.

18. The computing device of claim 17, wherein the first block size is 16×16 pixels, the second block size is 8×8 pixels, and the third block size is 4×4 pixels.

19. A non-transitory computer-readable medium including instructions that, when executed by a processing unit, cause the processing unit to perform an intra search, by performing the steps of:
performing a first intra search based on a first block size associated with a first pixel block included in a video frame to determine a first intra mode;
reconstructing the first pixel block based on the first intra mode to generate reconstructed pixel data;
performing, based on the reconstructed pixel data, a second intra search based on a second block size associated with a second pixel block included in the video frame, wherein the second block size is smaller than the first block size; and
determining a second intra mode based on the second intra search.

20. The non-transitory computer-readable medium of claim 19, wherein the first block size is 16×16 pixels, and the second block size is 8×8 pixels.
